(19) United States
(12) Patent Application Publication
(10) Pub. No.: US 2022/0274339 A1
(43) Pub. Date: Sep. 1, 2022

(54) OBJECT MODEL GENERATION

(71) Applicant: HEWLETT-PACKARD DEVELOPMENT COMPANY, L.P., Spring, TX (US)

(72) Inventors: Jordi Gonzalez Rogel, Sant Cugat del Valles (ES); Scott A. White, Boise, ID (US); Helen Balinsky, Bristol (GB); Alberto Such Vicente, Sant Cugat del Valles (ES); Sergio Gonzalez Martin, Sant Cugat del Valles (ES)

(73) Assignee: HEWLETT-PACKARD DEVELOPMENT COMPANY, L.P., Spring, TX (US)

(21) Appl. No.: 17/629,122

(22) PCT Filed: Oct. 29, 2019
(86) PCT No.: PCT/US2019/058514

§ 371 Date: Jan. 21, 2022

(51) Int. Cl. B29C 64/386; G06F 21/60

(52) U.S. Cl. CPC B29C 64/386; G06F 21/608; G06F 21/602; B33Y 50/02

(57) ABSTRACT

Object model data modification is described in which object model data defining a three dimensional model to be generated by a three-dimensional printer may be obtained. Data relating to a first sensitive portion of the model may be obtained, the first sensitive portion representing a portion of the model to be concealed. Modified object model data in generated, the modified object model data including a first version of the three dimensional model that is represented in a first pre-processing application without exposing the first sensitive portion, and including the first object model data defining the three dimensional model for printing by a three-dimensional printer.

### BACKGROUND

Three-dimensional (3D) objects generated by an additive manufacturing process may be formed in a layer-by-layer manner and, in one example, an object may be generated by solidifying portions of layers of build material. In other examples, 3D objects may be generated using extruded plastics or sprayed materials as build materials, which solidify to form an object.

Additive manufacturing systems may generate objects based on design data. This may involve a designer generating a 3D digital model of an object to be generated, for example using a computer aided design (CAD) application.

### BRIEF DESCRIPTION OF THE DRAWINGS

FIG. 1 is a schematic diagram showing components of a system according to an example;

FIG. 2 is a flow diagram showing a method of generating modified object model data according to an example;

FIG. 3 is a flow diagram showing a method of generating a first and second version of a 3D model according to an example;

FIG. 4 is an example of a computer readable medium comprising instructions to generate modified object model data according to an example;

FIG. 5 is a schematic diagram of a 3D printing system according to an example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

In an example of the disclosure, a process of producing a 3D-printed object to a particular specification may include: (i) part and build preparation; (ii) 3D printing; and (iii) post-processing. During the part and build preparation, a digital model of an object to be printed, comprising object model data representing the object, may be prepared by a designer using an editing or object generation application such as a CAD application. The object model data can define one or multiple 3D geometry models and/or 3D transform matrices which can position an object to be printed in a 3D printer's printable area. The object model data is in a format that can be read and interpreted by a 3D printer which can carry out a 3D printing build operation.

The object model data may be received by the 3D printer. The 3D printer may comprise a controller to generate printer control data comprising build data based at least in part on the received object model data relating to the object. The printer control data may further comprise instructions to cause the 3D printer to print the build. data.

An object model of an object may, for example, represent a new and/or experimental prototype of a future product, and maintaining confidentiality may protect a competitive edge of the product owner. This may be the case when the object model is to be 3D printed by a printer that is not under the control of the object model designer— e.g. when using a third party 3D printing service provider that owns the printer to print the object model. In another example, a model could contain private (e.g. personal, or patient) data, such that confidentiality should be maintained. In a further example, a model could be a high value part which is to be protected under rights management for manufacturing. However, in order to complete the manufacturing of an object that is to be based on object model data, the data may be exposed to various parties during a design and manufacturing workflow of a 3D object. For example, an object model data owner may offer the design for purchase, may wish to request a cost estimate or manufacturing schedule for generating an object, or may provide an object model to a party that is to pack the object with other object models of objects to be printed. In this way, object model data may be exposable to at least one third party. The object model of the object to be printed may have a number of portions including at least one sensitive portion and one non-sensitive portion. There may be a plurality of sensitive portions. A sensitive portion can represent data that is to be protected, for example, against unwarranted disclosure or exposure to a party using a first pre-processing application which does not have permission to access the sensitive portion. The non-sensitive portion may be exposed in the first pre-processing application.

In one example, when visually representing the object model in the first pre-processing application, the model may show an obfuscated portion that masks or conceals the sensitive portions of the object model. An example of obfuscation is replacing the portion with a geometrical shape bounding the region within which the portion is located such that the sensitive portions are concealed. Another example of obfuscation is applying a filter to the sensitive portion so as to obscure the region when visually represented on a display screen. The sensitive portions are capable of being concealed from view in the first pre-processing application. However, a 3D printer will be able to print the complete detailed object represented by the 3D model so will have access to any sensitive and non-sensitive portions of the 3D model. This may allow processing of the model that is sufficient to enable a party using the first pre-processing application to complete a task as part of the design and manufacturing workflow of a 3D object.

In order to visually represent the object model in the first pre-processing application with an obfuscated portion, the object model data of the model may be modified so as to generate modified object model data including a first version of the model that exposes non-sensitive portions of the model but not sensitive portions which are not to be exposed in the first pre-processing application. A number of versions of the 3D model may be created and each specific model version may be assigned, in the editing application for example, to each of a plurality of pre-processing applications. Each pre-processing application may have access to different sensitive portions of the 3D model by having access rights to a particular model version from the number of versions of the 3D model. Therefore, different pre-processing applications can have access to different obfuscated models with a pre-processing application being able to access to a particular model if it has access to the model version within which the particular model is contained. Each different pre-processing application may have access to sufficient content of the model which may be a subset of the content that can be accessed by another pre-processing application such that each pre-processing application can perform its task within the design and manufacturing workflow of the object.

The object model data and/or the modified object model data may be digitally secured to prevent unauthorised access. This may be achieved by encryption, for example. Each version of the model may be encrypted using a first encryption method that can be decrypted using a first decryption method such that access to a particular version is possible if a pre-processing application has access to the first decryption method. In an example, the first encryption method may comprise a first public encryption key and the first decryption method may comprise a first private decryption key.

The object model data and modified object model data may for example be stored using a 3MF (3D manufacturing) format or other file format capable of representing a 3D object.

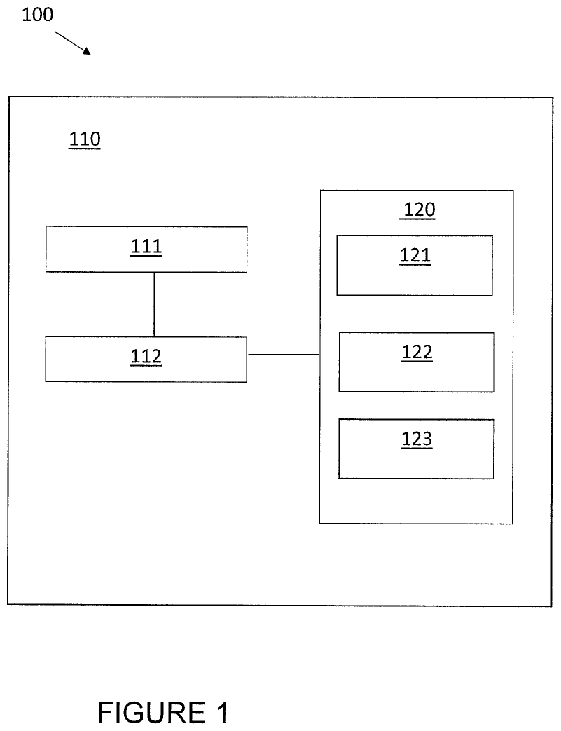

With reference to FIG. 1, there is shown an example system according to the present disclosure. In this example, the system 100 comprises a controller 110. The controller 110 may comprise a plurality of components, some of which are described below. The controller may be a programmable logic device (PLD) or other computing device that can carry out instructions. The controller may include multiple processing elements that are integrated in a single device as described in the example below or distributed across devices.

The controller 110 of the system 100 may comprise a data input/output interface unit 111 to receive input data from external components, for example, user input devices (not shown) to allow a user to interact with the system 100. The unit 111 may also output data from the controller 110 to other external components, for example, a display unit (not shown).

The controller 110 may further comprise a processor 112 to manage all the components within the controller 110, and process all data flow between the components within the controller 110. The processor may be any of a central processing unit, a semiconductor-based microprocessor, an application specific integrated circuit (ASIC), and/or other device suitable for retrieval and execution of instructions.

The controller 110 may further comprise a storage or memory unit 120 to store any data or instructions which may need to be accessed by, for example, the processor 112. The memory unit 120 may be any form of storage device capable of storing executable instructions, such as a non-transient computer readable medium, for example Random Access Memory (RAM), Electrically-Erasable Programmable Read-Only Memory (EEPROM), a storage drive, an optical disc, or the like.

In one example, the memory unit 120 includes instructions such as instructions to obtain 121 object model data defining a three dimensional model be generated by a three-dimensional printer, obtain 122 data relating to a first sensitive portion of the model, the first sensitive portion representing a portion of the model to be concealed, generate 123 modified object model data that includes a first version of the three dimensional model that is represented in a first pre-processing application without exposing the first sensitive portion, and includes the first object model data defining the three dimensional model for printing by a three-dimensional printer. The modified object model data may be stored for use by a 3D printer which can print the complete three dimensional model including any sensitive portions that were concealed in the first pre-processing application.

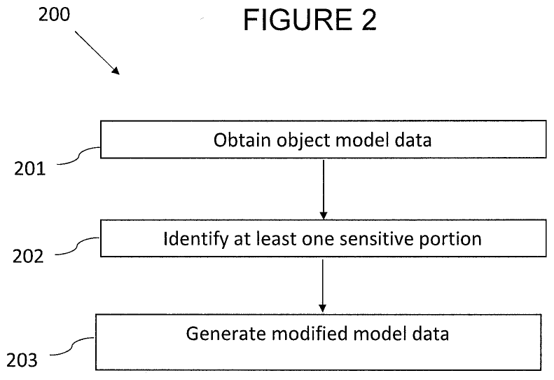

FIG. 2 shows an example of a method 200 for generating modified object model data including at least one version of an object model having a portion which is obfuscated from display. The modified object model data may be output from editing application that may be controlled by the controller 110 shown in FIG. 1. The method comprises obtaining 201 obtaining object model data defining a three dimensional model to be printed by a three-dimensional printer, the model comprising at least one sensitive portion and at least one non-sensitive portion. The data may be stored in any suitable manner, for instance, in an electronic file containing information pertaining to the objects including the object to be printed. The electronic file may be obtained from an external device or a local data store. In an example, the electronic file may be in a three dimensional manufacturing (3MF) file format. The method further comprises identifying 202 the at least one sensitive portion. This may be achieved by receiving a user input in, for example, an editing application to indicate the sensitive portion in the three dimensional model. The sensitive portion may be indicative of a portion of the model that is to be concealed from certain pre-processing applications that do not need access to the sensitive portion in order to complete a task and/or are not authorised to access the data relating to the sensitive portion. Alternatively, the identification of the sensitive portion may occur automatically after a three dimensional model has been obtained such as by displaying portions that are sensitive in the editing application based on data provided by the creator of the three dimensional model. At 203, modified object model data can be generated, the modified object model data including a plurality of versions of the model including a first version of the model that is visually represented to expose the at least one non-sensitive portion without exposing the at least one sensitive portion. The three dimensional model that also includes the sensitive portions is contained in the modified object model data as an encrypted version or encrypted portions such that when sent to a printer, the printer will print the complete object model including any sensitive portions that were concealed in the model. The printer may contain a decryption key to decrypt the encrypted version or encrypted portions of the object model that form part of the modified object model data. The modified object model data may be used to generate slices in a pre-print application of the complete object model which may then be transmitted to a 3D printer, or the slices may be generated within the printer itself based on the modified object model data. The printer may carry out a 3D printing operation of the complete object model on the basis of the modified object model data.

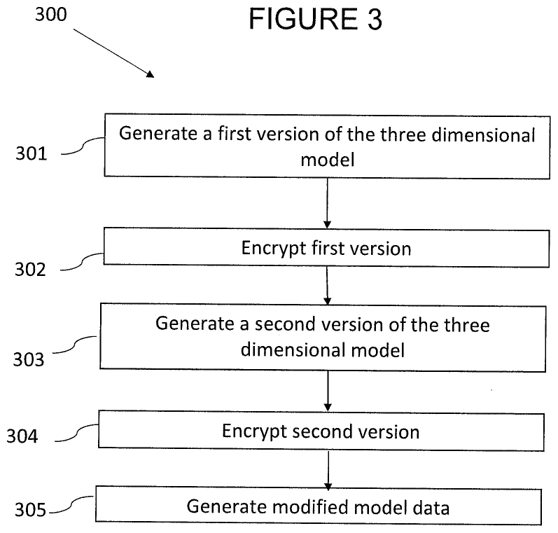

FIG. 3 shows a method 300 including a more detailed example in relation to block 203 of FIG. 2 that may be performed by the controller 110 of FIG. 1 and is an example of a generation of modified object model data. The method comprises generating 301 a first version of the three dimensional model that is to be visually represented to expose the at least one non-sensitive portion without exposing the at least one sensitive portion. At 302, access rights may be applied to the first version such that a first pre-processing application having access rights can access the first version. In one example of a cryptographic scheme, this may be achieved by encrypting the first version using a first encryption key or performing some other form of access restriction. The first encrypted version can be decrypted by a first decryption key and the first decryption key is made available to a first pre-processing application and/or other applications that have access rights to the first version such that the applications can decrypt the encrypted first version. The first encryption key may be a public key of the first pre-processing application and the first decryption key may be private key of the first pre-processing application. In another example of a cryptographic scheme, a secret key could be used to encrypt and decrypt one or more versions of the model and the secret key is encrypted and decrypted using a public/private key cryptographic scheme. For example, a symmetric secret key may be used to encrypt and decrypt the first version of the object model. The symmetric secret key itself may be encrypted using a public key and delivered to a first pre-processing application. The encrypted symmetric secret key is then decrypted using a private key that is available to the first pre-processing application. The encrypted first version is then decrypted using the decrypted symmetric secret key. Alternatively, at 302, the first version may not be encrypted such that no access rights are applied to the first version and the first version of the model including the exposed at least one non-sensitive portion and concealed one sensitive portion can be accessed by a plurality of applications in the design and manufacturing workflow.

At 303, a second version of the three dimensional model is generated that is to be visually represented to expose one other non-sensitive portion without exposing one other sensitive portion of the model. The at least one other sensitive portion may be different to and/or a subset of the at least one sensitive portion. Access rights can then be applied to the second version such that a second pre-processing application can access the second version. This may be achieved, for example, by encrypting 304 the second version using a second encryption key. The second encrypted version can be decrypted by a second decryption key and the second decryption key is made available to a second pre-processing application. The second encryption key may be a public key of the second pre-processing application and the second decryption key may be private key of the second pre-processing application. The original object model including all data needed to represent the complete model may be encrypted such that an application with the appropriate access rights to original model can access the complete model. The modified object model data is generated 305 to include the first and second encrypted versions and appropriate access rights to enable the complete object model including any modifications that have been made to the model during the design and manufacturing workflow to be printed by the printer.

In some examples, there may be multiple printers that can print a complete object model and each printer may provide its own public key to an editing application to encrypt a complete model and each printer with its own private key can decrypt the complete object model when it arrives at the printer.

In an example, the first pre-processing application may be a packing application that may need to approximate the actual shape of an object to provide efficient packing but would not need other attributes such as detailed shapes or colours relating to the object to be packed and printed. The second pre-processing application may be a pre-flight application that uses a model of the object to approximate the actual consumption so that a printer from a plurality of printers can be selected for printing the object model. For such an application, the shape of the model does not need to match the exact model shape and the model to be used by the pre-flight application can be obfuscated accordingly. Respective versions of the model can therefore be prepared that conceal or obfuscate any data in the model that does not relate to the task to which the pre-processing application relates and which may not be needed to perform the task. Where appropriate, multiple pre-processing applications may have access to the same obfuscated version of the model. Multiple versions of the same original object model may be provided and an editing application can assign a specific model version to a pre-processing application. The multiple versions may be provided in the same electronic file such as the same 3MF file.

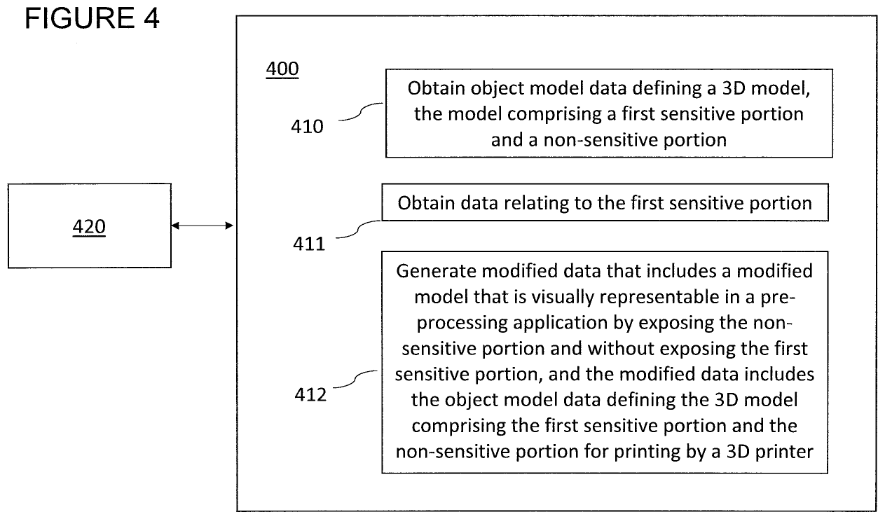

FIG. 4 shows a memory 400, which is an example of a computer readable medium storing instructions 410, 411, 412 that, when executed by a processor 420 communicably coupled to a computing device, may cause the processor 420 to generate modified object model data in accordance with any of the examples or flow diagrams described above. The computer readable medium may be any form of storage device capable of storing executable instructions, such as a non-transient computer readable medium, for example Random Access Memory (RAM), Electrically-Erasable Programmable Read-Only Memory (EEPROM), a storage drive, an optical disc, or the like.

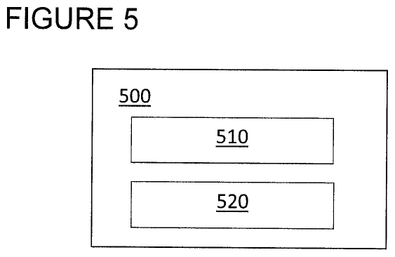

FIG. 5 shows a schematic view of a 3D printing system 500 comprising a controller 510. The controller 510 may be a programmable logic device (PLD) or other computing device that can carry out instructions. The controller 510 may include multiple processing elements that are integrated in a single device or distributed across devices. The controller 510 can generate printer control data comprising build data based at least in part on received object model data relating to the object. The printer control data may further comprise instructions to cause a 3D printer 520 to print the build. In an example, the controller 510 receives modified object model data such as that having been described in the above examples. The modified object model data may be received in an electronic file which may be in a three dimensional manufacturing (3MF) file format. In an example, the electronic file is based on that which was generated by the editing application described above in relation to FIG. 2 above. The modified object model data may include an encrypted first object model data defining a full version of a three dimensional object model for printing by the three-dimensional printer, and at least a first version of the three dimensional model that is representable in a first pre-processing application without exposing a first sensitive portion of the three dimensional model. The controller 510 may have a first decryption key which can be used to decrypt the encrypted first object model data. The decryption of the encrypted first object model data can reveal complete three dimensional object model including any sensitive portions of the model to enable the complete object model to be printed. The controller 510 can cause the printer 520 to carry out a 3D printing operation of the complete object model.

In addition to the examples described in detail above, the skilled person will recognize that various features described herein can be modified and/or combined with additional features, and the resulting additional examples can be implemented without departing from the scope of the system of the present disclosure, as this specification merely sets forth some of the many possible example configurations and implementations for the claimed solution.

1. A system comprising:
a controller to:
obtain first object model data defining a three dimensional model;
obtain data relating to a first sensitive portion of the model, the first sensitive portion representing a portion of the model to be concealed; and
generate modified object model data that includes a first version of the three dimensional model that is represented in a first pre-processing application without exposing the first sensitive portion, and includes the first object model data defining the three dimensional model for printing by a three-dimensional printer.

2. The system according to claim 1, wherein the first version of the model is visually represented in a first pre-processing application without exposing the first sensitive portion.

3. The system according to claim 1, wherein the first sensitive portion is obfuscated in the first version of the model when represented in the first pre-processing application to mask the first sensitive portion and a remaining portion of the first version of the model is not obfuscated in the first version of the model when represented in the first pre-processing application.

4. The system according to claim 1, wherein the model further comprises a second sensitive portion and the controller is to obtain data relating to the second sensitive portion, wherein the modified object model data includes a second version of the model that is to be represented in a second pre-processing application without exposing the second sensitive portion, wherein the second sensitive portion is different or a subset of the first sensitive portion.

5. The system according to claim 1, wherein the controller is to obtain data indicative that the model includes a plurality of sensitive portions including the first sensitive portion and wherein the generated modified object model data includes a respective version of the model of a plurality of versions including the first version, each respective version having the respective sensitive portion of the plurality of sensitive portions represented in one of a plurality of pre-processing application without exposing the respective sensitive portion of the plurality of sensitive portions.

6. The system according to claim 5, wherein the controller enables access by the first pre-processing application to one of the versions of the plurality of versions and to enable access by a second pre-processing application to another of the versions of the plurality of versions.

7. The system according to claim 1, wherein the controller causes a three-dimensional printer to print the three dimensional model including the first sensitive portion and the non-sensitive portion.

8. The system according to claim 1, wherein the controller is to obtain a first encryption key and to encrypt the first version using a first encryption key.

9. The system according to claim 8, wherein the controller is to cause:
obtaining of a first decryption key;
decrypting of the encrypted first version using the first decryption key; and
generating of a visual representation of the first version of the model.

10. The system according to claim 1, wherein the object model data defines a three dimensional model to be generated by a three-dimensional printer.

11. The system according to claim 1 wherein the modified object model data is in a three dimensional manufacturing file format.

12. A three-dimensional printing system comprising:
a controller to:
obtain modified object model data that includes a first version of a three dimensional model that is representable in a first pre-processing application without exposing a first sensitive portion of the model, and includes first object model data defining a full version of the three dimensional model for printing by a three-dimensional printer.

13. A method comprising:
obtaining object model data defining a three dimensional model to be printed by a three-dimensional printer, the model comprising at least one sensitive portion and at least one non-sensitive portion;
identifying the at least one sensitive portion;
generate modified object model data including a plurality of encrypted versions of the model including a first encrypted version of the model that is visually represented to expose the at least one non-sensitive portion without exposing the at least one sensitive portion, and the modified object model data including the three dimensional model comprising the at least one sensitive portion and the at least one non-sensitive portion to be printed by a three-dimensional printer.

14. The method according to claim 13, wherein the method further comprises enabling access by a first pre-processing application to the first encrypted version of the plurality of encrypted versions and enabling access by a second pre-processing application to another of the encrypted versions of the plurality of encrypted versions, the other of the encrypted versions of the model exposing one other non-sensitive portion without exposing one other sensitive portion of the model.

15. A non-transitory computer-readable medium comprising instructions, which when executed on a computing device, cause the computing device to:
obtain object model data defining a three dimensional model, the model comprising a first sensitive portion and a non-sensitive portion;
obtain data relating to the first sensitive portion;
generate modified data that includes a modified model that is visually representable in a pre-processing application by exposing the non-sensitive portion and without exposing the first sensitive portion, and the modified data includes the object model data defining the three dimensional model comprising the first sensitive portion and the non-sensitive portion for printing by a three-dimensional printer.
